(19) United States
(12) Patent Application Publication
(10) Pub. No.: US 2024/0040622 A1
(43) Pub. Date: Feb. 1, 2024

(54) APPARATUS AND METHOD PERFORMED BY THE SAME IN WIRELESS COMMUNICATION SYSTEM

(71) Applicant: Samsung Electronics Co., Ltd., Suwon-si (KR)

(72) Inventors: Sa ZHANG, Beijing (CN); Feifei SUN, Beijing (CN); Min WU, Beijing (CN)

(21) Appl. No.: 18/358,423

(22) Filed: Jul. 25, 2023

(30) Foreign Application Priority Data
Jul. 26, 2022 (CN) 202210885937.6
Aug. 3, 2022 (CN) 202210929483.8

(51) Int. Cl. H04W 74/08

(52) U.S. Cl. CPC H04W 74/0816

(57) ABSTRACT

The disclosure relates to a 5G or 6G communication system for supporting a higher data transmission rate. The present disclosure provides a method performed by a terminal in a wireless communication system, comprising receiving, from a base station, a configuration message including first configuration information associated with a downlink reception of the terminal and second configuration information associated with an uplink transmission of the terminal and in case that the first configuration information corresponds to a first state of the base station, refraining from receiving the downlink reception and in case that the second configuration information corresponds to the first state of the base station, refraining from transmitting the uplink transmission.

### CROSS-REFERENCE TO RELATED APPLICATION(S)

This application is based on and claims priority under 35 U.S.C. § 119(a) of a Chinese patent application number 202210885937.6, filed on Jul. 26, 2022, in the Chinese Intellectual Property Office, and of a Chinese patent application number 202210929483.8, filed on Aug. 3, 2022, in the Chinese Intellectual Property Office, the disclosure of each of which is incorporated by reference herein in its entirety.

### BACKGROUND

### 1. Field

The disclosure relates to the field of wireless communication. More particularly, the disclosure relates to an apparatus and a method performed by the same in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Aspects of the disclosure are to address at least the above-mentioned problems and/or disadvantages and to provide at least the advantages described below. Accordingly, an aspect of the disclosure is to provide an apparatus and a method performed by the same in a wireless communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving a downlink channel, and at least one of refraining from transmitting a first uplink channel or transmitting a second uplink channel.

In accordance with another aspect of the disclosure, a method performed by a base station in a wireless communication system is provided. The method includes transmitting a downlink channel to a terminal, and at least one of refraining from receiving a first uplink channel from the terminal or receiving a second uplink channel from the terminal.

In some implementations, for example, the terminal does not transmit the first uplink channel in case that a first predefined condition is satisfied.

In some implementations, for example, the terminal transmits the second uplink channel in case that a second predefined condition is satisfied.

In some implementations, for example, the second predefined condition includes at least one of:
the first predefined condition being satisfied,
the terminal being configured or indicated to be in a mode related to energy saving on a primary serving cell,
the terminal being configured or indicated to be in the mode related to energy saving on all serving cells,
the second uplink channel not overlapping with semi-static downlink symbols configured by higher layer signaling in a time domain,
the second uplink channel not overlapping with downlink symbols indicated by a downlink control information (DCI) in the time domain,
the second uplink channel not overlapping with a physical downlink shared channels (PDSCH) scheduled by a DCI on a same serving cell in the time domain,
the second uplink channel not overlapping with a physical uplink shared channel (PUSCH) scheduled by a DCI in the time domain,
the second uplink channel not overlapping with a predefined set of time units in the time domain,
a configuration of a scheduling request (SR) and/or a configuration of a configured grant (CG) PUSCH indicating that the SR and/or the CG PUSCH can be transmitted in the mode related to energy saving,
a logical channel corresponding to a configuration of a SR satisfying a fourth predefined condition,
a buffer status reporting (BSR) being triggered,
a SR being triggered,
uplink data corresponding to a PUSCH included in the second uplink channel being generated, or
an event indicating base station wake-up being triggered.

In some implementations, for example, the predefined set of time units includes at least one of a set of first time units associated with the mode related to energy saving, or a set of a predetermined number of time units before the first time units associated with the mode related to energy saving.

In some implementations, for example, when the first predefined condition is satisfied, the BSR is triggered in case that a first predetermined event occurs. The first predetermined event includes that for a first logical channel which belongs to a first logical channel group (LCG), uplink data becomes available to a medium access control (MAC) entity, and (i) the uplink data belongs to the first logical channel with a higher priority than a priority of any logical channel containing available uplink data, or (ii) none of the logical channels contains available uplink data, and/or the fourth predefined condition is satisfied.

In some implementations, for example, when the first predefined condition is satisfied, the BSR is triggered in case that a second predetermined event occurs. The second predetermined event includes that for a first logical channel which belongs to a first LCG, uplink data becomes available to an MAC entity, and a timer indicating BSR retransmission expires, and at least one logical channel contains available uplink data, and/or the fourth predefined condition is satisfied.

In some implementations, for example, in case that at least one BSR is triggered and not cancelled, and a regular BSR is triggered and a timer indicating SR delay for a logical channel is not running, and there is no uplink resource available for a new transmission, and a fifth predefined condition is satisfied, the SR is triggered.

In some implementations, for example, the event indicating base station wake-up is triggered in case that a predefined timer is running and/or the fifth predefined condition is satisfied. The predefined timer is configured to run in case that a sixth predefined condition is satisfied, the sixth predefined condition including at least one of the BSR being triggered, the SR being triggered, and the event indicating base station wake-up being triggered.

In some implementations, for example, the fifth predefined condition includes at least one of the first predefined condition being satisfied and the fourth predefined condition is satisfied, the first predefined condition being not satisfied, or the first predetermined event occurring.

In some implementations, for example, the fourth predefined condition includes one or more of:
the first predefined condition being satisfied,
the terminal being configured or indicated to be in the mode related to energy saving in the primary serving cell,
the terminal being configured or indicated to be in the mode related to energy saving on all serving cells,
a priority of a first logical channel being higher than a predefined threshold,
a configuration of the first logical channel, and/or a configuration of a physical channel corresponding to the first logical channel, and/or a first LCG being indicated by a higher layer parameter that the BSR can be triggered and/or can be transmitted in the mode related to energy saving,
the configuration of the physical channel corresponding to the first logical channel indicating that a parameter related to a physical layer priority is configured as a higher priority, or
uplink data of the first logical channel satisfying a predefined delay requirement.

For example, the physical channel corresponding to the first logical channel includes a SR and/or a CG PUSCH.

In some implementations, for example, the first predefined condition includes that the base station configures or indicates the terminal to be in the mode related to energy saving, and/or the base station configures the terminal with a higher layer parameter related to energy saving.

In some implementations, for example, the first uplink channel includes one or more of an uplink channel not carrying signaling indicating base station wake-up, an uplink channel not indicated by a downlink control information (DCI), an uplink channel not configured or indicated by higher layer signaling that it can be received in a mode related to energy saving, or uplink channels other than the second uplink channel.

In some implementations, for example, the second uplink channel includes one or more of an uplink channel carrying the signaling indicating base station wake-up, an uplink channel indicated by the DCI, an uplink channel configured or indicated by the higher layer signaling that it can be received in the mode related to energy saving, or uplink channels other than the first uplink channel.

According to some embodiments of the disclosure, a terminal in a wireless communication system is also provided. The terminal includes a transceiver, and a processor coupled to the transceiver and configured to perform one or more of operations in the above methods performed by the terminal.

According to some embodiments of the disclosure, a base station in a wireless communication system is also provided. The base station includes a transceiver, and a processor coupled to the transceiver and configured to perform one or more of operations in the above methods performed by the base station.

According to some embodiments of the disclosure, a computer-readable storage medium having one or more computer programs stored thereon is also provided, wherein the one or more computer programs, when executed by one or more processors, can implement any of the above-described methods.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features and advantages of certain embodiments of the disclosure will be more apparent from the following description taken in conjunction with the accompanying drawings, in which:

FIG. 1 illustrates a schematic diagram of an example wireless network according to an embodiment of the disclosure;

FIGS. 2A and 2B illustrate example wireless transmission and reception paths according to various embodiments of the disclosure;

FIG. 3A illustrates an example user equipment (UE) according to an embodiment of the disclosure;

FIG. 3B illustrates an example gNodeB (gNB) according to an embodiment of the disclosure;

FIG. 4 illustrates a block diagram of a second transceiving node according to an embodiment of the disclosure;

FIG. 5 illustrates a flowchart of a method performed by a UE according to an embodiment of the disclosure;

FIGS. 6A, 6B, and 6C illustrate some examples of uplink transmission timing according to various embodiments of the disclosure;

FIG. 7 illustrates a flowchart of a method performed by a terminal according to an embodiment of the disclosure;

FIG. 8 illustrates a block diagram of a first transceiving node according to an embodiment of the disclosure;

FIG. 9 illustrates a flowchart of a method performed by a base station according to an embodiment of the disclosure; and

FIG. 10 illustrates a flowchart of a method performed by a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, denotes to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” denotes any device, system, or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, denotes that different combinations of one or more of the listed items can be used, and only one item in the list can be needed. For example, “at least one of: A, B, and C” includes any of the following combinations: A, B, C, A, and B, A and C, B and C, and A and B and C. For example, “at least one of: A, B, or C” includes any of the following combinations: A, B, C, A, and B, A and C, B and C, and A, B, and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first,” “second,” and similar words used in the disclosure do not express any order, quantity or importance, but are only used to distinguish different components. Similar words such as singular forms “a,” “an,” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example,” “an implementation” or “implementation,” “an embodiment” or “embodiment,” denotes that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” a thing denotes “at least some of” the thing, and as such may mean less than all of, or all of, the thing. As such, “a portion of” a thing includes the entire thing as a special case, i.e., the entire thing is an example of a portion of the thing.

As used herein, the term “set” denotes one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded Similar words such as “connect” or “connected” are not limited to physical or mechanical connection, but can include electrical connection, whether direct or indirect. “Upper,” “lower,” “left,” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the application can be applied to future-oriented communication technologies.

Hereinafter, the embodiments of the disclosure will be described in detail with reference to the accompanying drawings. It should be noted that the same reference numerals in different drawings will be used to refer to the same elements already described.

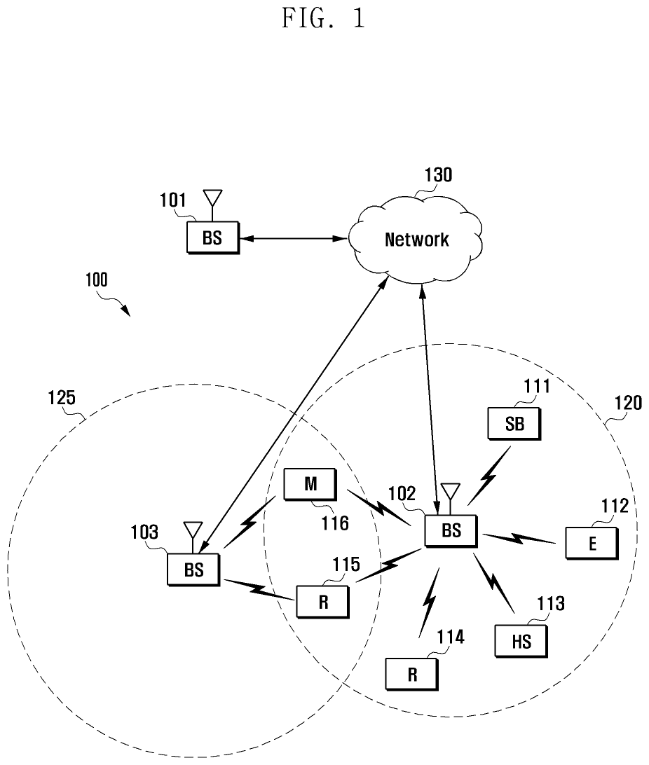

FIGS. 1, 2A, 2B, 3A, and 3B describe various embodiments implemented by using orthogonal frequency division multiplexing (OFDM) or orthogonal frequency division multiple access (OFDMA) communication technologies in wireless communication systems. The descriptions of FIGS. 1, 2A, 2B, 3A, and 3B do not mean physical or architectural implications for the manner in which different embodiments may be implemented. Different embodiments of the disclosure may be implemented in any suitably arranged communication systems.

FIG. 1 illustrates an example wireless network according to an embodiment of the disclosure. The embodiment of the wireless network shown in FIG. 1 is for illustration only. Other embodiments of the wireless network can be used without departing from the scope of the disclosure.

Referring to FIG. 1, a wireless network 100 includes a gNodeB (gNB) 101 (e.g., a base station (BS)), a gNB 102, and a gNB 103. The gNB 101 communicates with gNB 102 and gNB 103. The gNB 101 also communicates with at least one Internet Protocol (IP) network 130, such as the Internet, a private IP network, or other data networks.

Depending on a type of the network, other terms such as “base station (BS)” or “access point” can be used instead of “gNodeB” or “gNB.” For convenience, the terms “gNodeB” and “gNB” are used in this patent document to refer to network infrastructure components that provide wireless access for remote terminals. And, depending on the type of the network, other terms such as “mobile station,” “user station,” “remote terminal,” “wireless terminal,” or “user apparatus” can be used instead of “user equipment” or “UE.” For example, the terms “terminal,” “user equipment,” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a wireless-fidelity (Wi-Fi) Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to network 130 for a second plurality of UEs within a coverage area 125 of gNB 103. The second plurality of UEs include UE 115 and UE 116. In some embodiments, one or more of gNBs 101-103 can communicate with each other and with UEs 111-116 using 5G, Long Term Evolution (LTE), LTE advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two-dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

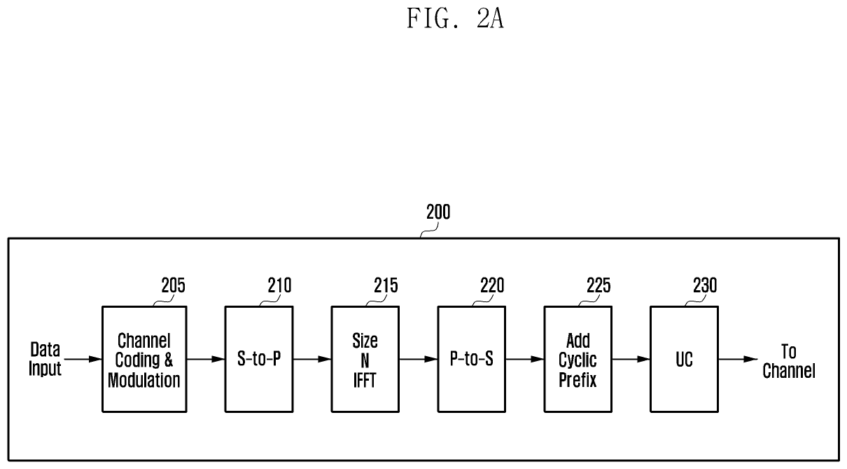

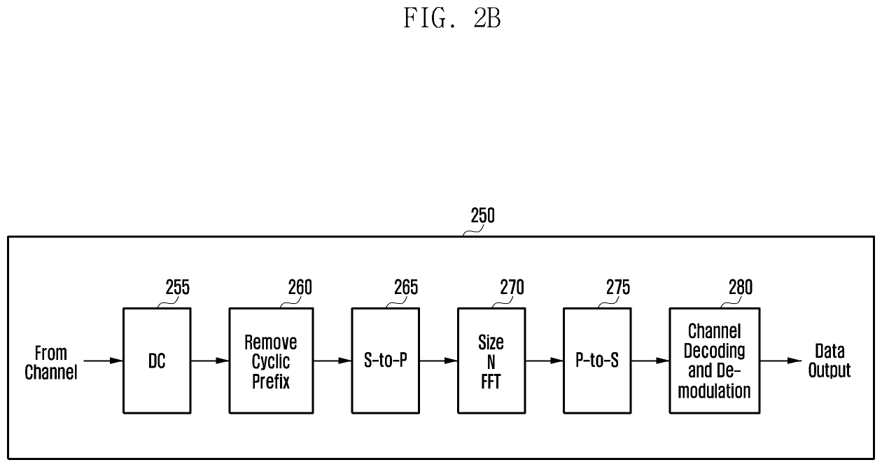

FIGS. 2A and 2B illustrate example wireless transmission and reception paths according to various embodiments of the disclosure. In the following description, the transmission path of FIG. 2A can be described as being implemented in a gNB, such as gNB 102, and the reception path of FIG. 2B can be described as being implemented in a UE, such as UE 116. However, it should be understood that the reception path of FIG. 2B, can be implemented in a gNB and the transmission path of FIG. 2A, can be implemented in a UE. In some embodiments, the reception path of FIG. 2B is configured to support codebook designs and structures for systems with 2D antenna arrays as described in embodiments of the disclosure.

Referring to FIGS. 2A and 2B, transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. Reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial (P-to-S) block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to a radio frequency (RF) frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement the transmission path 200 similar to that for transmitting to UEs 111-116 in the downlink, and may implement the reception path 250 similar to that for receiving from UEs 111-116 in the uplink. Similarly, each of UEs 111-116 may implement the transmission path 200 for transmitting to gNBs 101-103 in the uplink, and may implement the reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the size N FFT block 270 and the size N IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

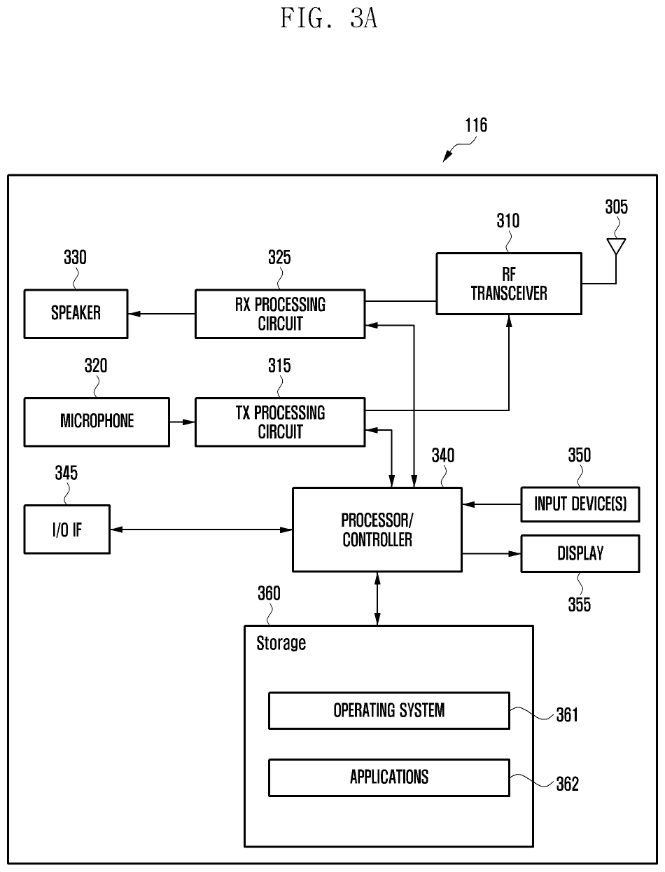

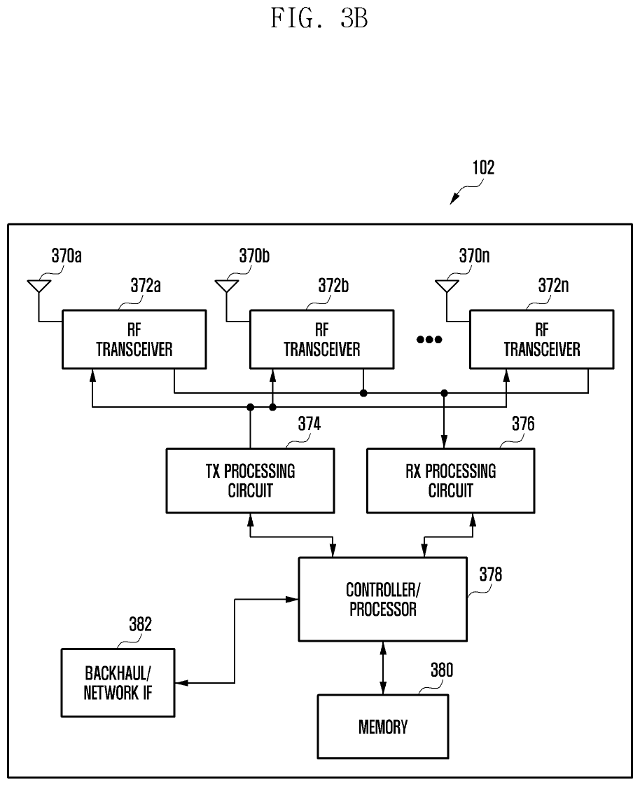

FIG. 3A illustrates an example UE according to an embodiment of the disclosure. The UE shown in FIG. 3A is for illustration only, and the UEs 111-115 of FIG. 1 can have the same or similar configuration. However, a UE has various configurations, and FIG. 3A does not limit the scope of the disclosure to any specific implementation of the UE.

Referring to FIG. 3A, UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface (IF) 345, an input device(s) 350, a display 355, and a memory 360 or storage. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute the OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the one or more applications 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB according to an embodiment of the disclosure. The gNB shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, the gNB 102 includes a plurality of antennas 370a, 370b, . . . 370n (hereinafter 370a-370n), a plurality of RF transceivers 372a, 372b, . . . 372n (hereinafter 372a-372n), a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface (If) 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web real-time communications (RTCs). The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a personal communications service (PCS), which may combine voice, data processing, fax and/or data communication capabilities; a Personal Digital Assistant (PDA), which may include a radio frequency receiver, a pager, an internet/intranet access, a web browser, a notepad, a calendar and/or a Global Positioning System (GPS) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a Mobile Internet Device (MID) and/or a mobile phone with music/video playing functions, a smart television (TV), a set-top box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. In International Telecommunication Union (ITU) report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3rd Generation Partnership Project (3GPP), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, an HARQ-ACK feedback delay is determined for a corresponding downlink subframe based on an uplink and downlink configuration. In 5G systems, whether FDD or TDD systems, for a determined downlink time unit (e.g., a downlink slot or a downlink mini slot), the uplink time unit that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-enhanced mobile broadband (eMBB), massive machine-type communication (mMTC) and ultra-reliable and low-latency communication (URLLC). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In 5G NR, due to the introduction of larger bandwidth and higher frequency band, the energy consumption of a base station is several times that of an LTE base station. Accordingly, how to reduce the energy consumption of the base station is a problem to be solved. Moreover, how to reduce the impact on the network performance while reducing the energy consumption of the base station is also a problem to be solved.

In order to solve at least the above technical problems, embodiments of the disclosure provide a method performed by a terminal, the terminal, a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Various embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

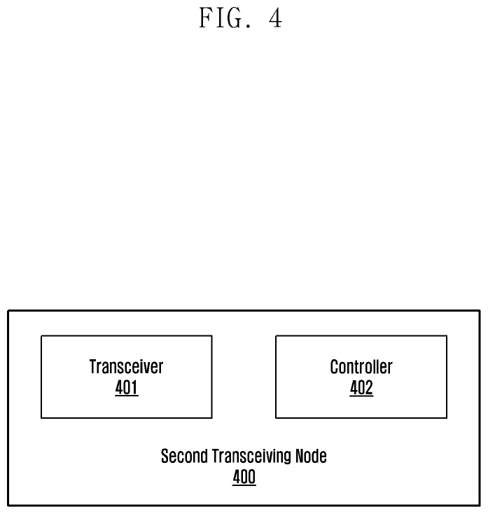

FIG. 4 illustrates a block diagram of the second transceiving node according to an embodiment of the disclosure.

Referring to FIG. 4, a second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

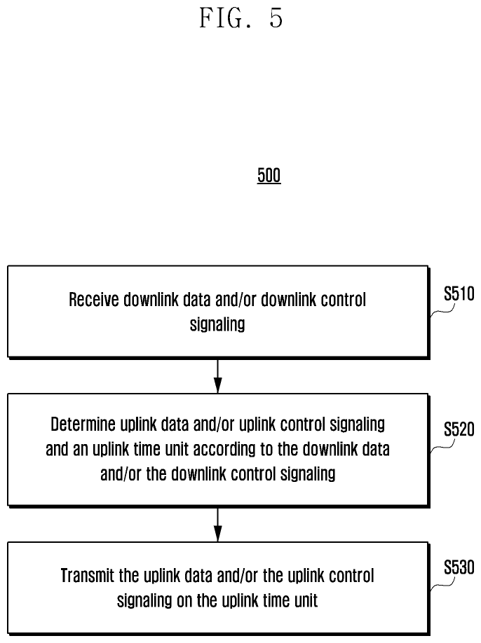

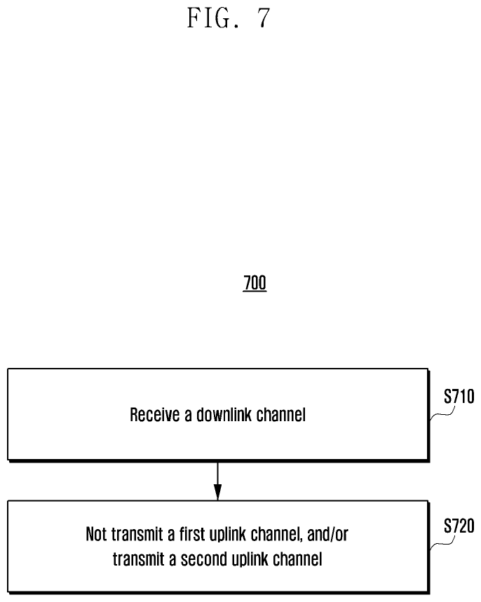

In some implementations, the controller 402 may be configured to perform one or more of operations in methods of various embodiments described below. For example, the controller 402 may be configured to perform one or more of operations in a method 500 to be described in connection with FIG. 5, and a method 700 to be described in connection with FIG. 7 later and/or operations performed by a terminal (e.g., UE) that are described according to various embodiments (for example, in manners MN1-MN7) of the disclosure.

In some implementations, the first data may be data transmitted by the first transceiving node to the second transceiving node. In the following examples, downlink data carried by a Physical Downlink Shared Channel (PDSCH) is taken as an example (but not limited thereto) to illustrate the first data.

In some implementations, the second data may be data transmitted by the second transceiving node to the first transceiving node. In the following examples, uplink data carried by a Physical Uplink Shared Channel (PUSCH) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be a downlink control information (DCI) carried by a Physical Downlink Control Channel (PDCCH) and/or control signaling carried by a Physical Downlink Shared Channel (PDSCH). For example, the DCI may be a UE specific DCI, and the DCI may also be a common DCI. The common DCI may be a DCI common to a part of UEs, such as a group common DCI, and the common DCI may also be a DCI common to all of the UEs. The DCI may be an uplink DCI (e.g., a DCI for scheduling a PUSCH) and/or downlink DCI (e.g., a DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be Uplink Control Information (UCI) carried by a Physical Uplink Control Channel (PUCCH) and/or control signaling carried by a Physical Uplink Shared Channel (PUSCH). A type of UCI may include one or more of: HARQ-ACK information, Scheduling Request (SR), Link Recovery Request (LRR), Chanel State Information (CSI) or Configured Grant (CG) UCI. In embodiments of the disclosure, when UCI is carried by a PUCCH, the UCI may be used interchangeably with the PUCCH.

In some implementations, a PUCCH with a SR may be a PUCCH with a positive SR and/or negative SR. The SR may be the positive SR and/or the negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit is taken as an example (but not limited thereto) to illustrate the first time unit.

In some implementations, a second time unit is a time unit in which the second transceiving node transmits the second data and/or the second control signaling. In the following examples, an uplink time unit is taken as an example (but not limited thereto) to illustrate the second time unit.

In some implementations, the first time unit and the second time unit may be one or more slots, one or more sub-slots, one or more OFDM symbols, one or more spans, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a Wi-Fi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (CE).

FIG. 5 illustrates a flowchart of a method performed by a UE according to an embodiment of the disclosure.

Referring to FIG. 5, in operation S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In operation S520, the UE determines uplink data and/or uplink control signaling and an uplink time unit based on the downlink data and/or downlink control signaling.

In operation S530, the UE transmits the uplink data and/or the uplink control signaling to the base station in an uplink time unit.

In some implementations, acknowledgement/negative acknowledgement (ACK/NACK) for downlink transmissions may be performed through HARQ-ACK.

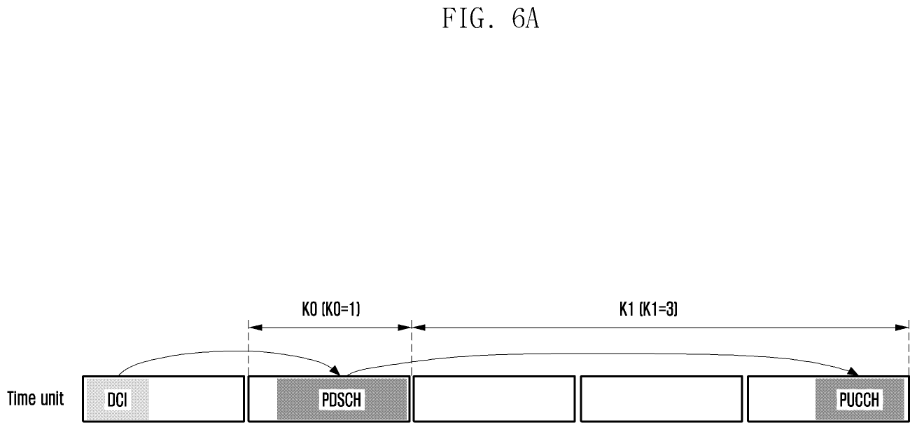

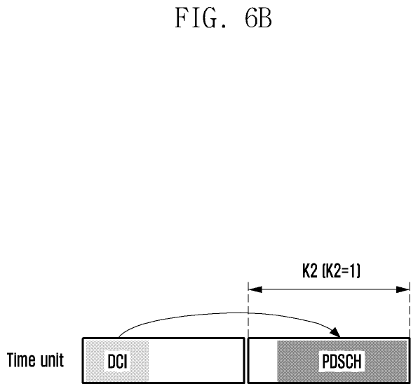

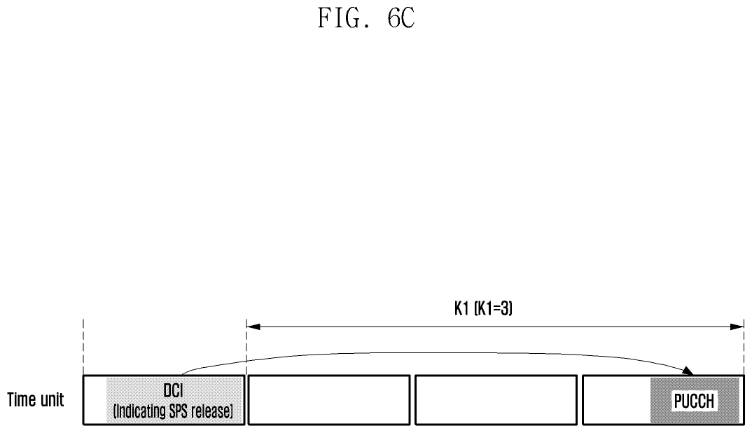

In some implementations, the downlink control signaling may include a DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A to 6C.

FIGS. 6A, 6B, and 6C illustrate some examples of uplink transmission timing according to various embodiments of the disclosure.

Referring to FIGS. 6A, 6B, and 6C, in an example, a UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 6A gives an example in which K0=1. In the example illustrated in FIG. 6A, the time interval from the PDSCH scheduled by the DCI to the PDCCH carrying the DCI is one slot. In embodiments of the disclosure, “a UE receives a DCI” may mean that “the UE detects the DCI.”

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 6B gives an example in which K2=1. In the example illustrated in FIG. 6B, the time interval between the PUSCH scheduled by the DCI and the PDCCH carrying the DCI is one slot. K2 may also represent a time interval between a PDCCH for activating a configured grant (CG) PUSCH and the first activated CG PUSCH. In examples of the disclosure, unless otherwise specified, the PUSCH may be a dynamically scheduled PUSCH (e.g., scheduled by a DCI) (e.g., may be referred to as dynamic grant (DG) PUSCH, in embodiments of the disclosure) and/or a PUSCH not scheduled by a DCI (e.g., CG PUSCH).

In yet another example, the UE receives the PDSCH, and may transmit HARQ-ACK information for the PDSCH reception in a PUCCH in the uplink time unit. For example, a timing parameter (which may also be referred to as a timing value) K1 (e.g., the parameter dl-DataToUL-ACK in 3GPP) may be used to represent a time interval between the PUCCH for transmitting the HARQ-ACK information for the PDSCH reception and the PDSCH, and K1 may be in units of uplink time units, such as slots or sub-slots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 6A gives an example in which K1=3. In the example illustrated in FIG. 6A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K₁, the timing parameter K0 may be used interchangeably with a timing parameter K₀, and the timing parameter K2 may be used interchangeably with a timing parameter K₂.

The PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by a DCI) and/or HARQ-ACK indicated by a DCI format (e.g., HARQ-ACK for a PDSCH reception scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the uplink time unit. For example, the timing parameter K1 may be used to represent a time interval between the PUCCH for transmitting the HARQ-ACK information for the DCI and the DCI, and K1 may be in units of uplink time units, such as slots or sub-slots. For example, FIG. 6C gives an example in which K1=3. In the example of FIG. 6C, the time interval between the PUCCH for transmitting the HARQ-ACK information for the DCI and the DCI is 3 slots. For example, the timing parameter K1 may be used to represent a time interval between a PDCCH reception carrying a DCI indicating SPS PDSCH release (deactivation) and the PUCCH feeding back HARQ-ACK for the PDCCH reception.

In some implementations, in operation S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in operation S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or an MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission. For example, the UE may be configured to multiplex UCIs with different priorities by higher layer signaling (e.g., through the 3GPP parameter UCI-MuxWithDifferentPriority), otherwise, the UE performs prioritization for PUCCHs and/or PUSCHs with different priorities. For example, the two levels of priorities may include a first priority and a second priority which are different from each other. In an example, the first priority may be higher than the second priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

The multiplexing of multiple PUCCHs and/or PUSCHs that overlap in the time domain may be multiplexing UCI information included in the PUCCHs in a PUCCH or PUSCH.

The prioritization of two PUCCHs and/or PUSCHs that overlap in the time domain by the UE may mean that the UE transmit a PUCCH or PUSCH with a higher priority, and does not transmit a PUCCH or PUSCH with a lower priority.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by a UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (which is referred to as G-RNTI in embodiments of the disclosure) for scrambling of a dynamically scheduled multicast transmission (e.g., PDSCH) or an RNTI (which is referred to as G-CS-RNTI in embodiments of the disclosure) for scrambling of a multicast SPS transmission (e.g., SPS PDSCH). The G-CS-RNTI and the G-RNTI may be different RNTIs or same RNTI. UCI(s) of the unicast PDSCH may include HARQ-ACK information, SR, or CSI of the unicast PDSCH reception. UCI(s) of the multicast PDSCH may include HARQ-ACK information for the multicast PDSCH reception. In embodiments of the disclosure, “multicast” may also be replaced by “broadcast.”

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be a PDCCH and/or DCI and/or DCI format. For example, an SPS PDSCH and/or CG PUSCH may be dynamically indicated in a corresponding activated a DCI/DCI format/PDCCH. All or one or more of the described methods, steps and operations may be optional. For example, if a certain parameter (e.g., parameter X) is configured, the UE performs in a certain manner (e.g., manner A), otherwise (if the parameter, e.g., parameter X, is not configured), the UE performs in another manner (e.g., manner B).

It should be noted that, a PCell (Primary Cell) or PSCell (Primary Secondary Cell) in embodiments of the disclosure may be used interchangeably with a cell having a PUCCH.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, downlink symbols may be replaced with uplink symbols, and downlink time units may be replaced with uplink time units, so that methods for downlink may be applicable to uplink.

It should be noted that, methods applicable to scheduling of multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured and/or indicated with a transmission with repetitions” may be understood that the number of the repetitions of the transmission is greater than 1. For example, “configured and/or indicated with a transmission with repetitions” may be replaced with “PUCCH repeatedly transmitted on more than one slot/sub-slot.” “Not configured and/or indicated with a transmission with repetitions” may be understood that the number of the repetitions of the transmission equals to 1. For example, “PUCCH that is not configured and/or indicated with repetitions” may be replaced by “PUCCH transmission with the number of the repetitions of 1.” For example, the UE may be configured with a parameter N_{PUCCH}^{repeat} related to the number of repetitions of PUCCH; When the parameter N_{PUCCH}^{repeat} is greater than 1, it may mean that the UE is configured with a PUCCH transmission with repetitions, and the UE may repeat the PUCCH transmission on N_{PUCCH}^{repeat} time units (e.g., slots); when the parameter is equal to 1, it may mean that the UE is not configured with a PUCCH transmission with repetitions. For example, the repeatedly transmitted PUCCH may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or DCI format schedules multiple PDSCHs/PUSCHs, which may be multiple PDSCHs/PUSCHs on a same serving cell and/or multiple PDSCHs/PUSCHs on different serving cells.

It should be noted that, the multiple manners described in the disclosure may be combined in any order. In a combination, a manner may be adopted one or more times.

It should be noted that, steps of methods of the disclosure may be implemented in any order.

It should be noted that, in methods of the disclosure, “canceling a transmission” may mean canceling the transmission of the entire uplink channel and/or cancelling the transmission of a part of the uplink channel.

It should be noted that, in methods of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in methods of the disclosure, a PUCCH/PUSCH carrying/with A may be understood as a PUCCH/PUSCH only carrying/with A, and may also be understood as a PUCCH/PUSCH carrying/with at least A.

It should be noted that “slot” may be replaced by “sub-slot” or “time unit” in embodiments of the disclosure.

It should be noted that, in embodiments of the disclosure, “a predefined method (or step) is performed if a predefined condition is satisfied” and “a predefined method (or step) is not performed if a predefined condition is not satisfied” may be used interchangeably. “A predefined method (or step) is not performed if a predefined condition is satisfied” and “a predefined method (or step) is performed if a predefined condition is not satisfied” may be used interchangeably.

In some cases, in order to reduce the energy consumption of the base station, the base station may operate in an energy-saving mode or sleep mode or predetermined mode (which may be referred to as “mode related to energy saving in embodiments of the disclosure), and for example, in the energy-saving mode or sleep mode or predetermined mode, the base station does not transmit downlink signals and/or the base station does not receive uplink signals. If the UE does not know that the base station is in the energy-saving mode, the UE may receive and/or decode downlink channels which are not transmitted by the base station, and/or the UE may transmit uplink channels, but the base station may not receive the uplink channels transmitted by the UE, resulting in the increase of energy consumption of the UE, the degradation of uplink transmission performance and the increase of interference to other serving cells.

In some implementations, an operating mode of the base station (e.g., whether it is the energy-saving mode) and/or an operating mode (or state) of the UE may be specified by protocols and/or configured by higher layer signaling and/or indicated by dynamic signaling. For example, there may be the following two modes, mode 1 and mode 2.

Mode 1 (it may also be referred to as “first mode” in embodiments of the disclosure): for example, mode 1 may be a non-energy-saving mode (also referred to as normal mode). In mode 1, normal communication (uplink transmission and/or downlink transmission) may be performed between the base station and the UE. For example, when in mode 1, the base station may transmit downlink channels and/or the base station may receive uplink channels. Or, when in mode 1, the UE may receive downlink channels transmitted by the base station and/or the UE may transmit uplink channels. It should be noted that, mode 1 may be an existing mode, for example, the mode in which the UE receives/transmits channels defined by 3 GPP Rel-15, Rel-16 or Rel-17.

Mode 2 (it may also be referred to as “second mode” in embodiments of the disclosure): for example, mode 2 may be the energy-saving mode or sleep mode. In mode 2, the base station may not perform some or all of downlink transmissions or uplink receptions. For example, when in mode 2, the base station may not transmit some or all of downlink channels and/or the base station may not receive some or all of uplink channels. Or, when in mode 2, the UE does not expect that the base station transmits some or all of downlink channels and/or the base station receives some or all of uplink channels.

In some implementations, a mode may be configured and/or indicated for the UE, where the mode is applicable to downlink reception and uplink transmission of the UE. For example, a mode may be configured and/or indicated for the UE in a serving cell, where the mode is applicable to downlink reception and uplink transmission of the UE on the serving cell. Behaviors of the UE in this mode (e.g., downlink reception methods and uplink transmission methods) may also be specified by protocols. This method is simple to implement and can save signaling overhead.

In some implementations, a mode may be configured and/or indicated separately for downlink reception and uplink transmission of the UE, for example, a downlink mode corresponding to downlink reception and an uplink mode corresponding to uplink transmission; and for example, for a serving cell in a TDD band, a mode may be configured and/or indicated separately for downlink reception and uplink transmission of the UE. Alternatively, a mode may be configured and/or indicated for downlink reception or uplink transmission of the UE. For example, for a serving cell in an FDD band, a mode may be configured and/or indicated for downlink reception or uplink transmission of the UE. Behaviors of the UE in the downlink mode (e.g., downlink reception methods) and/or behaviors of the UE in the uplink mode (e.g., uplink transmission methods) may also be specified by protocols. The UE may also report a UE capability of whether the UE supports a corresponding energy-saving mode separately for downlink reception and uplink transmission. This method can improve the flexibility of scheduling.

It should be noted that the embodiments of the disclosure may be applicable to one serving cell, and may also be applicable to multiple serving cells.

Manner MN1

In some implementations, in manner MN1, the base station may not receive a first predefined uplink channel (for example, the first predefined uplink channel may include a predefined PUCCH or PUSCH or a physical random access channel (PRACH)), and/or the base station may receive a second predefined uplink channel (for example, the second predefined uplink channel may include an uplink channel carrying base station wake-up signaling). For example, it may be specified by protocols that the UE does not transmit the first predefined uplink channel, and/or the UE transmits the second predefined uplink channel.

For convenience of description, the “first predefined uplink channel” and “second predefined uplink channel” are defined in the embodiments of the disclosure. For example, the “first predefined uplink channel” or “second predefined uplink channel” may refer to an uplink channel with a certain characteristic, or may refer to an uplink channel satisfying a certain condition. “Predefined” may mean that the channel may be set or configured or indicated or specified depending on different purposes. For example, “first predefined uplink channel” may be replaced by “first channel,” and “second predefined uplink channel” may be replaced by “second channel.” Examples of “first predefined uplink channel” and “second predefined uplink channel” will be described later.

In some implementations, it may be further defined in manner MN1 that when a first predefined condition is satisfied, the UE does not transmit the first predefined uplink channel, and/or the UE transmits the second predefined uplink channel. For example, the first predefined condition may include at least one of:
when the UE is configured or indicated to be in a specific mode (for example, in a serving cell, the UE is configured or indicated to be in a specific mode) (for example, the UE is configured or indicated to be in the second mode); or
the UE being configured with a higher layer signaling parameter related to network (or base station) energy saving (for example, the base station is in the energy-saving mode when the UE is configured with the higher layer signaling parameter).

In some implementations, it may be further defined in manner MN1 that the UE does not transmit the first predefined uplink channel when the first predefined condition is satisfied. For example, the first predefined uplink channel may be an uplink channel not carrying signaling indicating base station wake-up, and/or an uplink channel not indicated by a DCI, and/or an uplink channel not configured or indicated by higher layer signaling that it can be transmitted in the energy-saving mode. For another example, the first predefined uplink channel may be a non-second predefined uplink channel.

In some implementations, it may be further defined in manner MN1 that the UE transmits the second predefined uplink channel when a second predefined condition is satisfied. Additionally or alternatively, the UE does not transmit the second predefined uplink channel when the second predefined condition is not satisfied. Additionally or alternatively, the UE does not transmit the second predefined uplink channel when a third predefined condition is satisfied. Additionally or alternatively, the UE transmits the second predefined uplink channel when the third predefined condition is not satisfied. For example, the second predefined uplink channel may be an uplink channel carrying signaling indicating base station wake-up, and/or an uplink channel indicated by a DCI, and/or an uplink channel configured or indicated by higher layer signaling that it can be transmitted in the energy-saving mode. For another example, the second predefined uplink channel may be a non-first predefined uplink channel.

In some implementations, whether to transmit the second predefined uplink channel may be determined by judging whether the second predefined uplink channel (or a resource carrying the second predefined uplink channel) is valid. For example, the UE may transmit the second predefined uplink channel when the second predefined uplink channel (or the resource carrying the second predefined uplink channel) is determined to be valid. For example, the second predefined uplink channel (or the resource carrying the second predefined uplink channel) is valid when the second predefined condition is satisfied.

It should be noted that, the above implementations may be used in combination. In an example, the UE receives a downlink channel, and when the first predefined condition is satisfied, the UE does not transmit the first predefined uplink channel, and/or when the second predefined condition is satisfied, the UE transmits the second predefined uplink channel.

The method can reduce the transmission power of the UE by limiting the transmitting of the uplink channel, and at the same time, it can also reduce the blind detection of the base station, thereby reducing the power consumption of the base station.

Manner MN2

In some implementations, the second predefined condition may include at least one of:

the first predefined condition, as described in the embodiments of the disclosure.

When the UE is configured or indicated to be in a specific mode (for example, the UE is configured or indicated to be in the second mode) on a primary serving cell (e.g., an uplink primary serving cell).

when the UE is configured or indicated to be in a specific mode (for example, the UE is configured or indicated to be in the second mode) on all serving cells (e.g., all uplink primary serving cells).

the second predefined uplink channel not overlapping with semi-static downlink symbols configured by higher layer signaling (e.g., 3GPP parameter tdd-UL-DL-ConfigurationCommon and/or tdd-UL-DL-ConfigurationDedicated) in the time domain. This can reduce the interference to downlink transmission and improve the reliability of uplink transmission. It should be noted that symbols where synchronization signal and PBCH blocks (SSBs) are located may be considered as downlink symbols configured by higher layer signaling.

the second predefined uplink channel not overlapping with downlink symbols indicated by a DCI (e.g., DCI format 2-0) in the time domain. This can reduce the interference to downlink transmission and improve the reliability of uplink transmission.

the second predefined uplink channel not overlapping with PDSCH(s) scheduled by a DCI on a same serving cell in the time domain. This can reduce the interference to downlink transmission and improve the reliability of uplink transmission.

the second predefined uplink channel not overlapping with PUSCH(s) scheduled by a DCI in the time domain. When there is a PUSCH scheduled, it may be considered that it is in the non-energy-saving mode, which can reduce the transmission probability of the second predefined uplink channel and reduce the power consumption of the UE.

the second predefined uplink channel not overlapping with a predefined set of time units in the time domain. The predefined set of time units (e.g., symbols) may be at least one of:

a set of first time units in a specific mode (e.g., energy-saving mode). For example, the set of first time units may be a set of symbols in the energy-saving mode.

a set of second time units before the first time units in a specific mode (e.g., energy-saving mode). For example, the set of second time units may be a set of N symbols before the first time units in a specific mode (e.g., energy-saving mode). N may be an integer, and N may be configured by higher layer signaling or specified by protocols. This can reduce the transmission probability of the second predefined uplink channel and reduce the power consumption of the UE.

a higher layer signaling parameter in a configuration of a SR and/or a configuration of a CG PUSCH indicating that the SR and/or CG PUSCH may be transmitted in a specific mode (e.g., energy-saving mode). In this way, the transmission of the SR or CG PUSCH can be reduced, thereby reducing the blind detection of the base station and achieving the purpose of energy saving of the base station. At the same time, the transmission delay and reliability of a specific service can be guaranteed by signaling configuration, which increases the flexibility of scheduling.

a logical channel corresponding to a configuration of a SR satisfying a fourth predefined condition, as described in the embodiments of the disclosure.

a buffer status reporting (BSR) being triggered. For example, the BSR may be a regular BSR. In this way, the triggering mode of the BSR can be reused and the implementation complexity of the UE and/or base station can be reduced.

an SR being triggered. In this way, the triggering mode of the SR can be reused, and the implementation complexity of the UE and/or base station can be reduced.

uplink data (e.g., MAC protocol data unit (PDU)) corresponding to a PUSCH (e.g., CG PUSCH) of the second predefined uplink channel being generated. In this way, the transmission method of the PUSCH can be reused, and the implementation complexity of the UE and/or base station can be reduced.

an event indicating base station wake-up being triggered (for example, an MAC entity triggers the event indicating base station wake-up). For example, when the physical layer receives a base station wake-up indication (or event or report) triggered by the MAC entity, the UE may transmit an uplink channel carrying the base station wake-up signaling. For another example, when the physical layer receives the base station wake-up indication triggered by the MAC, the UE may transmit the second predefined uplink channel.

a first timer (e.g., as described in manner MN6) not running.

By defining the condition that needs to be satisfied when transmitting the second predefined uplink channel, the method can improve the transmission reliability of the second predefined uplink channel, thereby improving the performance of uplink transmission.

It should be noted that, the third predefined condition may be determined based on the second predefined condition. For example, “satisfying the second predefined condition” may be considered as “not satisfying the third predefined condition”, and “not satisfying the second predefined condition” may be considered as “satisfying the third predefined condition.”

It should be noted that, in the embodiments of the disclosure, “second predefined uplink channel” may be replaced by “time-domain resource carrying the second predefined uplink channel.”

Manner MN3

In some cases (for example, when the first predefined condition (as described in the embodiments of the disclosure) is satisfied, a BSR (e.g., a regular BSR) shall be triggered if the following event occurs (for example, for an activated cell group):
uplink data, for a logical channel (e.g., a first logical channel) which belongs to a Logical Channel Group (LCG) (e.g., a first LCG), becomes available to the MAC entity, and
this uplink data belongs to a logical channel (e.g., the first logical channel) with a higher priority than a priority of any logical channel containing available uplink data (e.g., any logical channel which belongs to any LCG), or none of the logical channels (e.g., any of the logical channels which belong to an LCG) contains any available uplink data; and/or
the fourth predefined condition is satisfied (or an event satisfying the fourth predefined condition occurs).

In some cases (for example, when the first predefined condition (as described in the embodiments of the disclosure) is satisfied, a BSR (e.g., a regular BSR) shall be triggered if the following event occurs (for example, for an activated cell group).

uplink data, for a logical channel (e.g., the first logical channel) which belongs to the first LCG, becomes available to the MAC entity, and

a timer indicating BSR retransmission (e.g., 3GPP parameter retxBSR-Timer) expires, and at least one of the logical channels (e.g., at least one of the logical channels which belong to any LCG) contains available uplink data; and/or

the fourth predefined condition is satisfied (or an event satisfying the fourth predefined condition occurs).

In some examples, the fourth predefined condition may include at least one of:

the first predefined condition (as described in the embodiments of the disclosure).

when the UE is configured or indicated to be in a specific mode (for example, the UE is configured or indicated to be in the second mode) on a primary serving cell (e.g., an uplink primary serving cell).

when the UE is configured or indicated to be in a specific mode (for example, the UE is configured or indicated to be in the second mode) on all serving cells (e.g., all uplink primary serving cells).

a priority of the first logical channel being higher than a predefined threshold. For example, the predefined threshold may be configured by a higher layer parameter. This can ensure the transmission delay and reliability of a logical channel with a higher priority.

a configuration of the first logical channel, and/or a configuration of a SR corresponding to the first logical channel, and/or the first LCG being indicated by a higher layer signaling parameter to trigger the BSR and/or to be transmitted in the energy-saving mode. For example, the parameter may be used to indicate that the BSR can be triggered in the energy-saving mode. In this way, the transmission of the SR with a low priority can be reduced, thereby reducing the blind detection of the base station and achieving the purpose of network (base station) energy saving. At the same time, the transmission delay and reliability of a specific logical channel can be ensured and the flexibility of scheduling can be increased.

a parameter indicating a physical layer priority in the configuration of the SR corresponding to the first logical channel being configured as a higher priority (for example, the parameter is configured as 1). In this way, the transmission of the SR with a lower physical layer priority can be reduced, thereby reducing the blind detection of the base station and achieving the purpose of network (base station) energy saving. Thus, the transmission delay and reliability of an uplink channel with a higher physical layer priority can be ensured.

data of the first logical channel satisfying a predefined delay requirement. For example, remaining available time (for example, the remaining available time may be remaining packet delay budget (PDB)) is less than a predefined threshold. This can ensure that the uplink transmission satisfies the delay requirement.

It should be noted that, the method for the SR in the embodiments of the disclosure is also applicable to a CG PUSCH. For example, “configuration of SR” may be replaced by “configuration of CG PUSCH.”

The above manner can reduce the probability of triggering a specific BSR, thus reducing the transmission of the SR or CG PUSCH, thereby reducing the blind detection of the base station and achieving the purpose of network (base station) energy saving. At the same time, the manner can guarantee the transmission delay and reliability of a service with a higher priority by signaling configuration, and increase the flexibility of scheduling.

Manner MN4

In some implementations, the MAC entity may trigger a scheduling request when a fifth predefined condition is satisfied. An example in which the MAC entity triggers the scheduling request is described below.

In an example, the MAC entity shall:
1> if the Buffer status reporting procedure determines that at least one BSR has been triggered and not cancelled:
   2> if a regular BSR has been triggered and a timer parameter indicating SR delay for a logical channel (e.g., 3GPP parameter logicalChannelSR-DelayTimer) is not running, and the fifth predefined condition is satisfied:
      3> if there is no UL-SCH resource available for a new transmission:
         trigger a scheduling request.

For example, the fifth predefined condition may include at least one of:
the first predefined condition (as described in the embodiments of the disclosure) being satisfied and the fourth predefined condition (as described in the embodiments of the disclosure) being satisfied;
the first predefined condition being not satisfied; or
a condition under which the BSR is triggered that is defined in the methods according to the embodiments of the disclosure being satisfied.

In an example, the MAC entity shall:
1> if the Buffer status reporting procedure determines that at least one BSR has been triggered and not cancelled:
   2> if a regular BSR has been triggered and a timer parameter indicating SR delay for a logical channel (e.g., 3GPP parameter logicalChannelSR-DelayTimer) is not running, and a higher layer signaling parameter related to energy saving (e.g., energy saving for the network (base station)) is not configured:
      3> if there is no UL-SCH resource available for a new transmission:
         trigger a scheduling request.

The method can reduce the uplink transmission of the base station in the energy-saving state, thereby reducing the blind detection of the base station and saving the energy consumption of the base station.

Manner MN5

In some implementations, a base station wake-up indication (or event or report) is triggered when the fifth predefined condition (as described in the embodiments of the disclosure) is satisfied. For example, the MAC entity triggers the base station wake-up indication (or event or report). When the physical layer receives the base station wake-up indication (or event or report) of the MAC, the UE may transmit an uplink channel carrying the base station wake-up signaling. By transmitting the base station wake-up signaling, the delay of uplink transmission can be reduced.

Manner MN6

In some implementations, the first timer may be configured by higher layer signaling. For example, the first timer may be used to trigger the base station wake-up indication. As an example, the first timer may be a timer parameter that triggers the base station wake-up indication (or event or report). The first timer starts when a sixth predefined condition is satisfied.

For example, the sixth predefined condition may include at least one of:
the BSR being triggered;
the scheduling request being triggered;
the base station wake-up indication (or event or report) being triggered.

In some implementations, when the fifth predefined condition (as described in the embodiments of the disclosure) is satisfied and the first timer is not running, the base station wake-up indication (or event or report) is triggered.

In the method, the transmission frequency of the base station wake-up indication is controlled by the timer, so that frequent transmission of the base station wake-up indication can be avoided and the power consumption of the UE can be reduced.

Manner MN7

In some implementations, if an uplink grant (or a UL-SCH resource or PUSCH resource corresponding to the uplink grant) satisfies at least a seventh predefined condition, the MAC entity generates (or obtains) an MAC PDU, otherwise, the MAC entity does not generate (or does not obtain) the MAC PDU. If a PUSCH satisfies an eighth predefined condition, the MAC entity does not generate (or does not obtain) the MAC PDU. This can avoid that the MAC PDU cannot be transmitted using a CG PUSCH after the MAC PDU is generated, improve the flexibility of scheduling and reduce the transmission delay of uplink data.

As some examples, the seventh predefined condition may be one of:
the first predefined condition being satisfied and the UL-SCH (or PUSCH) resource being available;
the first predefined condition being not satisfied, as described in the embodiments of the disclosure.

As some examples, the eighth predefined condition may be determined based on the seventh predefined condition. For example, “satisfying the seventh predefined condition” may be considered as “not satisfying the eighth predefined condition”, and “not satisfying the eighth predefined condition” may be considered as “satisfying the seventh predefined condition.”

In some implementations, for each uplink grant, a HARQ entity shall:
1> identify the HARQ process associated with this grant, and for each identified HARQ process:
   2> if the uplink grant is a part of a bundle of configured uplink grants and may be used for an initial transmission, and if no MAC PDU has been obtained for the bundle, and if the uplink grant (or the UL-SCH resource or PUSCH resource corresponding to the uplink grant) satisfies the seventh predefined condition:
      3> else if the MAC entity is not configured or indicated with a parameter indicating logical channel-based prioritization (e.g., 3GPP parameter lch-basedPrioritization); or
      3> if this uplink grant is a prioritized uplink grant,
         4> obtain an MAC PDU to transmit.

In some implementations, if a ninth predefined condition is satisfied, the UL-SCH (or PUSCH) resource is available. For example, the ninth predefined condition may include one of:
the first predefined condition (as described in the embodiments of the disclosure) being satisfied and the UL-SCH (or PUSCH) resource not overlapping with time units used for the energy-saving mode (for example, time units where the energy-saving mode is located);
the first predefined condition (as described in the embodiments of the disclosure) being not satisfied.

When the UE generates the MAC PDU in the energy-saving mode and the base station does not know it, the method can avoid that the MAC PDU cannot be transmitted through a HARQ retransmission, thereby improving the reliability of uplink transmission.

FIG. 7 illustrates a flowchart of a method performed by a terminal according to an embodiment of the disclosure.

Referring to FIG. 7, in operation S710, a terminal receives a downlink channel.

In operation S720, the terminal does not transmit a first uplink channel (e.g., the first predefined uplink channel described in various embodiments of the disclosure) and/or the terminal transmits a second uplink channel (e.g., the second predefined uplink channel described in various embodiments of the disclosure).

In some implementations, for example, not transmitting the first uplink channel in operation S720 may include not transmitting the first uplink channel in case that a first predefined condition is satisfied.

In some implementations, for example, transmitting the second uplink channel in operation S720 may include transmitting the second uplink channel in case that a second predefined condition is satisfied.

In some implementations, for example, the second predefined condition may include at least one of:
the first predefined condition being satisfied;
the second uplink channel not overlapping with semi-static downlink symbols configured by higher layer signaling in the time domain;
the second uplink channel not overlapping with downlink symbols indicated by a downlink control information (DCI) in the time domain;
the second uplink channel not overlapping with a physical downlink shared channel (PDSCH) scheduled by a DCI on a same serving cell in the time domain;
the second uplink channel not overlapping with a physical uplink shared channel (PUSCH) scheduled by a DCI in the time domain;
the second uplink channel not overlapping with a predefined set of time units in the time domain;
a configuration of a scheduling request (SR) and/or a configuration of a configured grant (CG) PUSCH indicating that the SR and/or the CG PUSCH can be transmitted in a mode related to energy saving;
a logical channel corresponding to a configuration of a SR satisfying a fourth predefined condition;
a buffer status reporting (BSR) being triggered;
an SR being triggered;
uplink data corresponding to a PUSCH included in the second uplink channel being generated; or
an event indicating base station wake-up being triggered.

In some examples, for example, the predefined set of time units may include at least one of: a set of first time units associated with the mode related to energy saving (for example, for the mode related to energy saving); or a set of a predetermined number N of time units before the first time units associated with the mode related to energy saving (for example, for the mode related to energy saving).

In some implementations, for example, when the first predefined condition is satisfied, the BSR may be triggered in case that a first predetermined event occurs.

In some examples, the first predetermined event may include that:
for a first logical channel which belongs to a first logical channel group (LCG), uplink data becomes available to a medium access control (MAC) entity, and
(i) the uplink data belongs to the first logical channel with a higher priority than a priority of any logical channel containing available uplink data, or
(ii) none of the logical channels contains available uplink data; and/or
the fourth predefined condition is satisfied.

In some implementations, for example, when the first predefined condition is satisfied, the BSR may be triggered in case that a second predetermined event occurs.

In some examples, the second predetermined event may include that:
for a first logical channel which belongs to a first LCG, uplink data becomes available to an MAC entity, and a timer indicating BSR retransmission expires, and at least one logical channel contains available uplink data; and/or
the fourth predefined condition is satisfied.

In some implementations, for example, if at least one BSR is triggered and not cancelled, and a regular BSR is triggered and a timer indicating SR delay for a logical channel is not running, and there is no uplink resource available for a new transmission, and a fifth predefined condition is satisfied, the SR may be triggered.

In some implementations, for example, the event indicating base station wake-up may be triggered in case that a predefined timer is running and/or the fifth predefined condition is satisfied.

In some examples, the predefined timer may be configured to run in case that a sixth predefined condition is satisfied, the sixth predefined condition including at least one of the BSR being triggered, the SR being triggered, and the event indicating base station wake-up being triggered.

In some examples, the fifth predefined condition may include at least one of:
the first predefined condition being satisfied and the fourth predefined condition is satisfied;
the first predefined condition being not satisfied; or
the first predetermined event occurring.

In some examples, the fourth predefined condition may include one or more of:
the first predefined condition being satisfied;
a priority of a first logical channel being higher than a predefined threshold;
a configuration of the first logical channel, and/or a configuration of a physical channel corresponding to the first logical channel, and/or a first LCG being indicated by a higher layer parameter that the BSR can be triggered and/or can be transmitted in the mode related to energy saving;
the configuration of the physical channel corresponding to the first logical channel indicating that a parameter related to a physical layer priority is configured as a higher priority; or
uplink data of the first logical channel satisfying a predefined delay requirement.

For example, the physical channel corresponding to the first logical channel may include an SR and/or a CG PUSCH.

In some implementations, for example, operation S720 may include: generating an MAC protocol data unit (PDU) for uplink transmission in case that an uplink grant or an uplink transmission resource corresponding to the uplink grant satisfies at least a seventh predefined condition; and/or not generating the MAC PDU for uplink transmission in case that the uplink grant or the uplink transmission resource corresponding to the uplink grant does not satisfy the seventh predefined condition.

In some examples, the seventh predefined condition may include at least one of: the first predefined condition being satisfied and the uplink transmission resource corresponding to the uplink grant being available; or the first predefined condition being not satisfied.

In some examples, the uplink transmission resource may be determined to be available based on at least one of: the first predefined condition being satisfied and the uplink transmission resource corresponding to the uplink grant not overlapping with time units used for the mode related to energy saving; or the first predefined condition being not satisfied.

In some implementations, for example, the first predefined condition may include that: the terminal is configured or indicated to be in the mode related to energy saving; and/or the terminal is configured with a higher layer parameter related to energy saving.

In some implementations, for example, the first uplink channel may include one or more of:
an uplink channel not carrying signaling indicating base station wake-up;
an uplink channel not indicated by a downlink control information (DCI);
an uplink channel not configured or indicated by higher layer signaling that it can be transmitted in a mode related to energy saving; or
uplink channels other than the second uplink channel.

In some implementations, for example, the second uplink channel may include one or more of:
an uplink channel carrying the signaling indicating base station wake-up;
an uplink channel indicated by the DCI;
an uplink channel configured or indicated by the higher layer signaling that it can be transmitted in the mode related to energy saving; or uplink channels other than the first uplink channel.

In some implementations, operations S710 and/or S720 may be performed based on the methods described according to various embodiments (for example, in manners MN1-MN7) of the disclosure.

In some implementations, the method 700 may omit operation S710, or include additional operations, for example, operations performed by the terminal (e.g., UE) that are described according to various embodiments (for example, in manners MN1-MN7) of the disclosure.

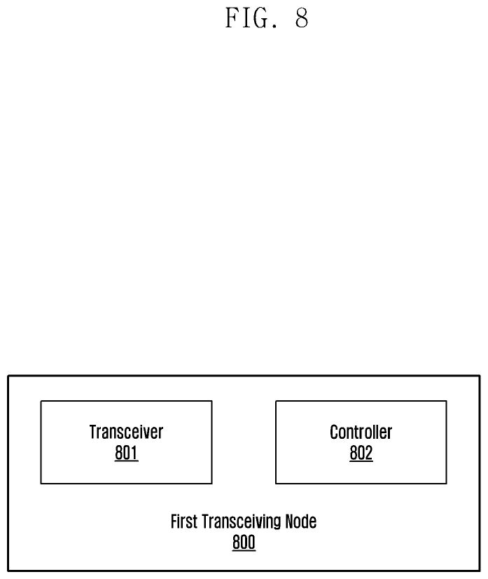

FIG. 8 illustrates a block diagram of a first transceiving node according to an embodiment of the disclosure.

Referring to FIG. 8, a first transceiving node 800 may include a transceiver 801 and a controller 802.

The transceiver 801 may be configured to transmit first data and/or first control signaling to a second transceiving node and receive second data and/or second control signaling from the second transceiving node in a time unit.

The controller 802 may be an application specific integrated circuit or at least one processor. The controller 802 may be configured to control the overall operation of the first transceiving node, including controlling the transceiver 801 to transmit the first data and/or the first control signaling to the second transceiving node and receive the second data and/or the second control signaling from the second transceiving node in a time unit.

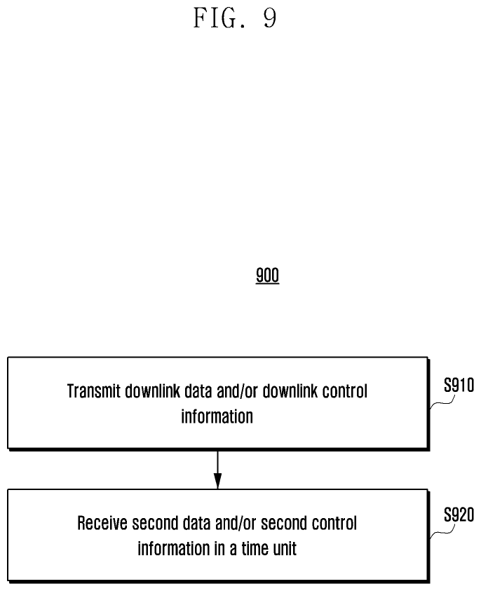

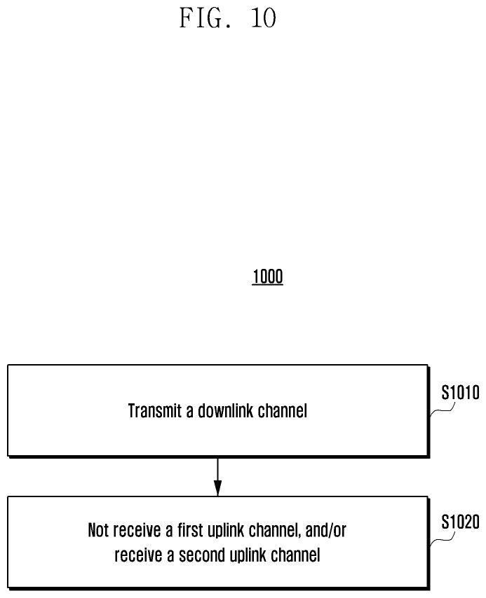

In some implementations, the controller 802 may be configured to perform one or more of operations in the methods of various embodiments described above, for example, operations in the method to be described in connection with FIG. 9, operations in the method to be described in connection with FIG. 10 and/or operations performed by the base station that are described according to various embodiments (for example, in manners MN1-MN7) of the disclosure.

In the following description, a base station is taken as an example (but not limited thereto) to illustrate the first transceiving node, a UE is taken as an example (but not limited thereto) to illustrate the second transceiving node. Downlink data and/or downlink control signaling (but not limited thereto) are used to illustrate the first data and/or the first control signaling. An HARQ-ACK codebook may be included in the second control signaling, and uplink control signaling (but not limited thereto) is used to illustrate the second control signaling.

FIG. 9 illustrates a flowchart of a method performed by a base station according to an embodiment of the disclosure.

Referring to FIG. 9, in operation S910, a base station transmits downlink data and/or downlink control information.

In operation S920, the base station receives second data and/or second control information from a UE in a time unit.

For example, method 900 of FIG. 9 may include one or more of operations performed by the base station that are described in various embodiments (for example, in manners MN1-MN7) of the disclosure.

FIG. 10 illustrates a flowchart of a method performed by a base station according to an embodiment of the disclosure.

Referring to FIG. 10, in operation S1010, the base station transmits a downlink channel to a terminal.

In operation S1020, the base station does not receive a first uplink channel (e.g., the first predefined uplink channel described in various embodiments of the disclosure) from the terminal, and/or the base station receives a second uplink channel (e.g., the second predefined uplink channel described in various embodiments of the disclosure) from the terminal.

In some implementations, operations S1010 and/or S1020 may be performed based on the methods described according to various embodiments (for example, in manners MN1-MN7) of the disclosure.

In some implementations, method 1000 of FIG. 10 may omit operation S1010, or include additional operations, for example, operations performed by the base station that are described according to various embodiments (for example, in manners MN1-MN7) of the disclosure.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the disclosure of the disclosure as generally described herein and shown in the drawings may be arranged, replaced, combined, separated and designed in various different configurations, all of which are contemplated herein.

Those skilled in the art will understand that the various illustrative logical blocks, modules, circuits, and operations described in this application may be implemented as hardware, software, or a combination of both. To clearly illustrate this interchangeability between hardware and software, various illustrative components, blocks, modules, circuits, and operations are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The operations of the method or algorithm described in this application may be embodied directly in hardware, in a software module executed by a processor, or in a combination thereof. The software module may reside in RAM memory, flash memory, ROM memory, erasable programmable read only memory (EPROM) memory, electrically erasable programmable ROM (EEPROM) memory, register, hard disk, removable disk, or any other form of storage medium. A storage medium is coupled to a processor to allow the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, a configuration message including first configuration information associated with a downlink reception of the terminal and second configuration information associated with an uplink transmission of the terminal;
in case that the first configuration information corresponds to a first state of the base station, refraining from receiving the downlink reception; and
in case that the second configuration information corresponds to the first state of the base station, refraining from transmitting the uplink transmission.

2. The method of claim 1, further comprising:
receiving a dynamic signaling associated with a state of the base station; and
determining the state of the base station, based on the configuration message and the dynamic signaling.

3. The method of claim 1, further comprising:
in case that the first configuration information corresponds to a second state of the base station, receiving the downlink reception; and
in case that the second configuration information corresponds to the second state of the base station, transmitting the uplink transmission.

4. A method performed by a base station in a wireless communication system, the method comprising:
transmitting, to a terminal, a configuration message including first configuration information associated with a downlink reception of the terminal and second configuration information associated with an uplink transmission of the terminal;
in case that the first configuration information corresponds to a first state of the base station, refraining from transmitting the downlink reception of the terminal; and
in case that the second configuration information corresponds to the first state of the base station, refraining from receiving the uplink transmission of the terminal.

5. The method of claim 4, further comprising:
generating a dynamic signaling associated with a state of the base station; and
transmitting the dynamic signaling.

6. The method of claim 4, further comprising:
in case that the first configuration information corresponds to a second state of the base station, transmitting the downlink reception of the terminal; and
in case that the second configuration information corresponds to the second state of the base station, receiving the uplink transmission of the terminal.

7. A terminal in a wireless communication system, the terminal comprising:
a transceiver configured to transmit and receive a signal; and
a processor coupled to the transceiver,
wherein the processor is configured to:
receive, from a base station, a configuration message including first configuration information associated with a downlink reception of the terminal and second configuration information associated with an uplink transmission of the terminal,
in case that the first configuration information corresponds to a first state of the base station, refrain from receiving the downlink reception, and
in case that the second configuration information corresponds to the first state of the base station, refrain from transmitting the uplink transmission.

8. The terminal of claim 7, wherein the processor is further configured to:
receive a dynamic signaling associated with a state of the base station; and
determine the state of the base station, based on the configuration message and the dynamic signaling.

9. The terminal of claim 7, wherein the processor is further configured to:
in case that the first configuration information corresponds to a second state of the base station, receive the downlink reception; and
in case that the second configuration information corresponds to the second state of the base station, transmit the uplink transmission.

10. A base station in a wireless communication system, the base station comprising:
a transceiver configured to transmit and receive a signal; and
a processor coupled to the transceiver,
wherein the processor is configured to:
transmit, to a terminal, a configuration message including first configuration information associated with a downlink reception of the terminal and second configuration information associated with an uplink transmission of the terminal,
in case that the first configuration information corresponds to a first state of the base station, refrain from transmitting the downlink reception of the terminal, and
in case that the second configuration information corresponds to the first state of the base station, refrain from receiving the uplink transmission of the terminal.

11. The base station of claim 10, wherein the processor is further configured to:
generate a dynamic signaling associated with a state of the base station; and
transmit the dynamic signaling.

12. The base station of claim 10, wherein the processor is further configured to:
in case that the first configuration information corresponds to a second state of the base station, transmit the downlink reception of the terminal; and
in case that the second configuration information corresponds to the second state of the base station, receive the uplink transmission of the terminal.
